(19) United States
(12) Patent Application Publication
(10) Pub. No.: US 2024/0193496 A1
(43) Pub. Date: Jun. 13, 2024

(54) EVALUATION SYSTEM OF THE PROCESSING TIMES IN THE MANUFACTURING SECTOR

(71) Applicant: PROGRESS LAB S.R.L., Vicenza (IT)

(72) Inventor: Luca Sorgiacomo, Vicenza (IT)

(73) Assignee: PROGRESS LAB S.R.L., Vicenza (IT)

(21) Appl. No.: 18/286,148

(22) PCT Filed: Apr. 13, 2022
(86) PCT No.: PCT/IB2022/053456

§ 371 Date: Oct. 9, 2023

(30) Foreign Application Priority Data
Apr. 15, 2021 (IT) 102021000009515

(51) Int. Cl. G06Q 10/04; G06Q 50/04

(52) U.S. Cl. CPC G06Q 10/04; G06Q 50/04

(57) ABSTRACT

The present invention indicates an information processing system that can be exploited in a large number of manufacturing companies, which work on order.

In such companies, the experience of the workers is a strategic and essential resource; the present invention transforms the substance of such experience, from a purely humanistic entity into a technical factor in all respects: a heritage preserved in the memories of computer systems. The invention consists in teaching the use of known mathematical tools derived from identification theory, to extract and encode the aforementioned wealth of experience. The inventive step consists in the fact that, although the necessary data and information are potentially available, a sample of training data, as such, suitable for using an identification model, is in fact not available, nor it is trivial to derive it from the data that are actually available.

### TECHNICAL BACKGROUND OF THE INVENTION

### 1. Field of the Invention

The present invention finds its preferred application in the manufacturing field, and addresses the need to predict delivery times for specific productions, in production contexts characterized by significant uncertainty.

The invention is particularly useful in the case of manufacturing companies that work on order.

### 2. Brief Description of the Prior Art

Production processes in the manufacturing sector are, in general, relatively complex processes, as they require a series of operational jobs, some of which can be performed simultaneously, while others must necessarily be performed in succession and, in some cases, precise timelines between the different operational jobs, can be recommended. Each operational job requires the use of some company resources, intended both as human resources, with specific skills or tasks, and as machinery and plants in general.

In the following, the generic term “work center” will be used to indicate a specific corporate entity, composed of various corporate resources (personnel, machinery, plants, laboratories, etc.) appointed to perform a specific operational job.

Furthermore, for the execution of each operational job, the materials to be processed or the semi-finished products must obviously be available, which may come from the company itself (for example from the warehouse or from a previous processing), but they can also come from external subjects, such as the customer, or a supplier, or a subcontractor entrusted with particular processes.

In this general framework, it is clear that the organization of the production process should be preceded by a careful planning, and it is also understood how inefficient or excessively approximate planning can lead to waste of time, even very significant, as the complexity, and articulation of the production process, increases.

In order to provide an aid to the planning of a production process in the manufacturing sector, methodologies and IT tools have been developed, specifically to allow for the optimization of the organization of production in a manufacturing company.

These methodologies and IT tools can be considered relatively mature and consolidated tools; they find wide and effective application in all contexts in which the productions are quite repetitive, and in which, once the production of one or more product batches has been planned, they can be put into production according to the planned timing; being the production unexpected events handled as exceptions.

The manufacturing context on order is quite different, in this context the company is the custodian of specialized skills and abilities, but which must be applicable with the greatest flexibility. In these contexts of production to order, the productions are in general always different. It is observed that, even if the productions related to two distinct orders can be very similar, normally, even apparently small differences can make it too complex to combine the two productions in a unified (or partially unified) process; therefore it is very common that the productions to serve each individual order are planned independently, and that the planning of both orders is essentially limited to taking into account not to interfere in the request for the same resources at the same time.

In general, it can be said that the production processes in a manufacturing company are processes characterized by elements of uncertainty, in particular the processes associated with the satisfaction of production to order, where planning is often not carried out in such a way as to take into account of all the possible factors that can interfere with the planned processes.

Some of the factors that can accentuate the uncertainty of the processes concern the “human factor” and the “asynchrony” in the acquisition of orders.

With reference to the human factor, it is noted that the allocation of workers or technicians to specific job orders may be affected by the actual availability, which in turn depends on the general priorities of the company, which, in general, is engaged on several orders, each of which can be subject to unforeseen events. The resources allocated then can have different levels of efficiency, specialization and, ultimately, different speed of execution of certain processes.

In addition, the orders are acquired with timing that is not dependent on the company. It is unrealistic to assume that orders can always be executed in order of acquisition (once one is finished, another begins), nor would it be efficient to execute them in that order.

In fact, it is the company's goal to exploit its resources as much as possible, then some processes can be performed, regardless of the order of arrival of the order that requests them, or the commitments related to delivery deadlines: some processes could be done simply because there are workers available, which otherwise would not be engaged and, in these cases, it could happen that some workers are employed in activities that do not correspond to their main competence, so that they are slower in execution.

The only way to try to use company resources by exploiting them 100% (or almost) is to acquire orders in large quantities, but this accentuates the difficulty of optimal planning, and the uncertainty in the completion times of the work.

It is therefore a strong point of manufacturing companies that work on orders to have highly experienced staff, able to plan work with the flexibility to best adapt the potential of their company to perform the work. Expert and attentive staff are able to manage in a satisfactory way the work in companies that work mostly on orders; however, there is still a margin of uncertainty in the timing, which it would be better to reduce.

Often, in order not to run the risk of not meeting the deadlines agreed with the customer, companies undertake commitments with a certain margin; it is not uncommon for delivery times to be indicated in a time window, sometimes quite wide.

But the contraindications are not limited only to the uncertainty about the time to complete the job. In fact, even the uncertainty of completing intermediate processes generates inefficiency, as it does not allow for the precise planning of other operational jobs, regarding other job-orders, as the timing with which certain resources can be freed and made available for other job-orders is not reliable.

Ultimately, the planning that can be implemented with this work organization is not always the optimal one.

In the context of manufacturing companies that work on order, the most widespread practice is to increase the management control, so as to cope at least with the minimum objective, which is to monitor precisely and punctually, at least for a final balance, the progress of real processes.

The real scenario, in which the teachings of the present invention are introduced, is that of manufacturing companies that already have significant information regarding the final balance of their work, but which implement manufacturing processes with a significant degree of uncertainty in the timing, which would be desirable to reduce. These are companies that often generate significant volumes of information regarding the performance of their manufacturing processes, but which use this information essentially for the classic management control purposes: that is, to measure their efficiency, how profitable they are, and to identify aspects of their organization where to intervene to correct critical situations.

Among the analyzes that can be carried out on the data collected in the final balance, it is also worth noting the possibility of providing a statistical characterization of anything that, as noted above, is perceived as random as it cannot be accurately predicted. Among the variables considered random, there are the start and end times of the individual processes, their duration, and the probability that a schedule concerning an order, or individual operational jobs, will be modified one or more times. It is clear that by having final balance values on these events, it is possible to estimate their statistical characterization, and this statistical characterization can be used, among other things, to simulate production processes, obtaining more realistic simulations of the same.

As mentioned, therefore, the computerization of manufacturing processes associated with the production on order is proceeding decisively, especially on the management control front, while on the planning issues, especially in small to medium-sized companies, advanced planning tools are not so widespread, and these companies still prefer to rely on the experience of their workers, and on their ability to adapt to contingent situations; this practice being, to date, still the most advantageous.

The known art, also at the level of patent production, proposes, as a main way to reduce the uncertainty of the manufacturing processes, the introduction of increasingly complex planning tools. However, these clash with many companies in the real world, as they require an excessive computerization: something that is happening, but with a physiological gradualness, and that realistically will be realized with different degrees of partiality, and not homogeneously, depending on the different cases.

Furthermore, a strong and objective planning of work, in the cases where the “human factor” weighs a lot, cannot always be modeled with the same precision with which the work executed by machinery can be modeled.

Therefore, most of the planning tools proposed by the known art are not adequate to solve the real problems of many companies, and presumably they will not yet be for a fairly long period of time.

We now mention, just by way of example, some solutions covered by patents or patent applications, which represent the state of the art in addressing the above-mentioned problems.
Doc. 1: US 2020/0285224 A1 [“Managing apparatus and managing system”, Koshiishi, H. et al.]-Sep. 10, 2020
Doc.2. US 2019/0258230 A1 [“Information management system”, Chiba, K. el al.]-Aug. 22, 2019
Doc.3: CN 109934443 A [“A digital on-line process planning and guiding system”, Shi Gang el al.]-Jun. 25, 2019
Doc.4: CN 109934425 A [“An intelligent factory customization planning system and method”, Ouyang Haishan]-Jun. 25, 2019
Doc.5: 2020/0285224 A1 [“Asset management devices and methods”, Mich E. et al.] Jun. 4, 2020
Doc.6: CN 111260316 A [“Management and control integrated platform for project management”, Yu Quanxing et al.]-Jun. 9, 2020
Doc.7: CN 111240283 A [“Adaptable planning design simulation platform construction method for intelligent manufacturing system”, Wang Taiyong et al.]-Jun. 5, 2020
Doc.8: U.S. Pat. No. 5,432,887 A [“Neural Network system and method for factory floor scheduling”, Fook C. Khaw]-Jul. 11, 1995
Doc.9: U.S. Pat. No. 5,093,794 A [“Job scheduling system”, Howie G. R. et al.]-Mar. 3, 1992
Doc. 10: “Predicting production times through machine learning for scheduling additive manufacturing orders in a PCC system”, Baumung W. et al.]-IEEE (ICIASE), Apr. 26, 2019
Doc. 11: “A Scheduling Support System-SSS”, Masayuki E. et al.]-Oct. 1, 1990

In all the cited documents, but there are also others, there are proposed solutions for the planning of the production processes; these solutions start from final balance data, describing real manufacturing processes as they took place, and seek optimizations to be made to improve the planning for the future.

In none of the proposed solutions, however, an answer is offered that can be applied to processes that are always different and subject to a randomness due to factors that cannot be modeled. In fact, the most felt need by many companies that work on order is to be able to better manage unexpected events, even small unforeseen events, being able to predict them better than what happens now, where you can only rely on the experience of the workers.

In the great majority of cases, which occur concretely in common practice, according to the state of the art, each job-order that is acquired by a manufacturing company can be defined, at a high level, by three objective elements:
i. the type of product to be made,
ii. the quantity of pieces to be produced, and
iii. the deadline by which the order must be completed.

The type of product allows you to identify the company resources that must be involved, and the set of operational jobs that must be carried out. The job order, therefore, according to the common practice adopted in the state of the art, is analyzed and broken down into a sequence of individual operational jobs, which must be carried out in a certain order. The process of planning the operational jobs associated with each acquired job order then proceeds by assigning the individual operational jobs to the available work centers in order to satisfy the other elements that characterize the order: quantity and delivery times. In the event that the company is out of work, it is very likely that company resources are available; in this case, the planning process can be carried out without particular difficulties, but this is certainly not an optimal condition for the company, because it means that it is working below its potential.

On the other hand, if the company is well committed on other job orders (that is more desirable) the resources required by an operational job could be allocated to work on other job orders. It is then necessary to change the allocation of resources previously allocated to other job orders; and this practice, however, also modifies the forecasts of the completion times of other orders and, in general, requires the reallocation of company resources in a way that was not predictable in a deterministic way.

Therefore, on the one hand, every single operational job can be characterized by typical timing and predictable resource commitments, that is, it can be defined through its own “performance specifications”; on the other hand, the real scheduling of machining is not easily predictable, because machining can undergo interruptions, slowdowns and even changes on the operational level, for example, it may be necessary to reassign certain operational jobs to working centers with different performances.

Therefore, in the perspective of the internal organization, the estimates on the completion times of the various scheduled operational jobs, and in general of the various job orders, start from an initial evaluation based on the so-called “performance specifications” associated with the individual operational jobs, but then one must take into account, necessarily approximate, of a margin of delay.

A further factor that prevents a precise evaluation of the completion times of a job order consists in the fact that, at the planning level, in general, the individual operational jobs are assigned to a work center, or to a type of equivalent work centers, and they are allocated in priority queues.

Therefore, the forecast on the completion of the various operational jobs depends on their position in these priority queues, and on the completion of the preceding operational jobs, and this aspect also determines uncertainty in the completion times of an entire job order. An improvement in timing estimates can certainly be obtained thanks to a statistical characterization, as accurate as possible, of the various processes that make up the production process as a whole. Nonetheless, processes must continue to be treated as random processes.

In order to manage these uncertainties, which, for what has been said, are to be considered physiological uncertainties in the manufacturing processes that affect companies that work on order (and which, in a certain sense, are also an index of the state of health of a company, because the uncertainties are generally determined by a lot of work), the manufacturing processes are monitored in an extremely punctual way, with information technologies that implement very efficient management control programs, in many cases able to provide monitoring substantially in real time.

So that in many real contexts, the more companies are able to acquire job orders in such a number as to significantly engage their production resources (understood both as workers, and as plants and machinery, and as logistical capabilities), the more the processes are affected by uncertainty in the timing of completion, and the more companies are forced to implement management control processes that produce large quantities of final data.

Of course, the management of uncertainties through the statistical characterization of everything that appears to be random is a good practice, and it is the first thing that can be implemented by exploiting the large volumes of final data that are produced by the systems for the monitoring of the production process, and by the management control systems.

However, a further improvement can be sought in an attempt to reduce this uncertainty, even it is considered physiological, by better interpreting the processes that, in the state of the art, appear to be processes affected by substantially random factors.

### SUMMARY OF THE INVENTION

The general purpose of the present invention, therefore, is to indicate a system, and the relative method that, in the face of the acquisition of a job-order, can foresee the development of processing times.

Being the purpose of this forecast not just to be able to communicate more accurately to the customer the timing of completion of the whole job-order, but also to estimate intermediate times, which are also useful for the possible planning of other work on order.

As explained above, forecasts based on an increasingly accurate modeling of the overall manufacturing processes of an entire company are very complex. In fact, the individual job-orders are planned individually, and they are individually subject to events that, to date, must be considered random.

Then, any setbacks that concern a specific job-order can also have repercussions on other orders, in a more or less predictable and articulated way, which depends on different causes, also characterized by uncertainty, such as the choices and decisions of the workers who manage the operativity of the company.

In addition, although companies are increasingly automated, there is still a significant incidence of operational manual work performed by workers, whose performance is obviously also characterized by a certain degree of uncertainty.

Consequently, an effective way to improve the accuracy of forecasts is certainly to build on past experiences. After all, past experience is nothing more than that wealth of knowledge held by the company's most experienced workers, who are considered so valuable. These experienced workers are often able to reasonably assess the delivery times of a certain work, going beyond the official “performance specification”, as they are aware that real work is characterized by dynamics that are not immune to setbacks and unforeseen events.

Today, the large availability of data from management control systems offers a wealth of experience encoded in IT form, which cannot be assimilated by a human operator. The precious skills of which the most expert workers are custodians, in fact, can be exploited effectively only in very stable contexts, in which some dynamics are repeated regularly over time.
The modern scenarios of the manufacturing industry, on the other hand, have different characteristics: they are rapidly evolving, and offer ever new dynamics that do not give the time to a human operator to mature and consolidate the experience necessary to make accurate predictions on the progress of work;
they offer information that encodes the past experience in a computerized way, without losing almost any effect, but such information is too large to be assimilated by a person.

Therefore, another purpose of the present invention is to use the monitoring data about the past job orders to make forecasts on the orders in the process of being acquired. An intermediate purpose of the present invention is therefore to structure the information coming from the management control systems, and in particular from the computerized monitoring systems of the manufacturing processes, so that these data can be usable by the tools made available by the mathematical methods for the “identification of complex models”, and not just to synthesize, with tools offered by the statistical formalism, events that today appear to be affected by considerable uncertainty.

These mathematical identification methods appear to be suitable tools for capturing all the experience that companies continually accumulate simply by working on orders, each in its own sector and in its own operating context.

In the context of the present invention, it is intended to resort to such tools to reduce the dynamics of the variables that must continue to be treated as random. After all, it is physiologically impossible to hope to reach levels of understanding such as to remove any uncertainty in what happens; however, the amount of data produced by modern management control systems is such as to suggest to go beyond mere statistical characterization, and to investigate more deeply the mechanisms that are spontaneously established in the production processes of manufacturing companies that work on order: mechanisms that are not clearly legible, due to the complexity of the real context.

An essential technical problem therefore arises, which concerns all the mathematical identification techniques, and which decisively conditions their performance: namely the coding and formal representation of the set of data to be used in the learning algorithms. These data must allow the identification of non-obvious rules that underlie the operation of complex systems.

The results of the present invention therefore complement, and do not replace, the statistical characterization of the events associated with the production processes, however they aim to reduce the random component, which today must be considered in making any estimate. It is clear that accurate estimates bring benefits both on the customer communication front and on the internal organization front.

The computerized processing of information, that constitutes a real wealth of experience of an organization, is now an opportunity since the IT tools are increasingly advanced, and the availability of information is growing significantly.

However, computer processing of this wealth of experience is not just an opportunity: today it is also a necessity. In fact, experience, understood in the classical sense, and which is gradually formed in people, is no longer possible either in the manufacturing world or in all modern economic and social contexts, characterized as they are by a growing dynamism, as well as by a super-production of computer data, which certainly cannot be processed, if not electronically.

Such data can be produced, initially, for mere monitoring purposes, for the extraction of synthetic indexes, and for the statistical characterization of phenomena that today have areas of uncertainty; however, such data contains a great deal of other information, which the present invention aims to extract to make predictions on the progress of the processes associated with orders in the process of being acquired.

The aims set for this invention are achieved by resorting to a forecasting system comprising a digital subsystem, implemented with computing means and memory units, configured to store an informatic representation of data concerning the following entities.
all the job-orders already acquired by a manufacturing firm, at a generic time “Tacc”, in which a new job-order is acquired, including information regarding their planning,
said new acquired job-order in said generic time “Tacc”, also including information regarding the first planning following the acquisition of the new job-order itself,
all the job-orders acquired by a manufacturing firm, in a time subsequent to the time “Tacc”, when also said new acquired job-order has been planned to be executed (obviously, said computer representation also includes information regarding any necessary re-planning),
all the job-orders carried out by said manufacturing firm, including information regarding the real actual execution of the orders, and, in particular, information concerning the real actual moments in which all the individual operational jobs have begun and finished, and information also concerning the work centers that have actually carried out these operational jobs.

Being said forecasting system, according to the invention, characterized in that said computing means and memory units are also configured to calculate and produce a set of data suitable for constituting a training database for a mathematical identification model for modelling a complex system.

And being said training database consisting of single samples with a vector structure, in which each of said samples is associated with a single operational job belonging to an executed job-order, and consists of an input vector and an output vector appropriately structured.

Said input vector is structured to accommodate at least the following information regarding the single operational job associated with the sample considered, information available at the time Tacc” of acquisition, or at the time of the first planning, including:
information strictly related to the first planning of the considered operational job (times and assigned working center),
information related to the job-order to which said operational job belongs, and to the position of the operational job itself within the job-order,
and context information regarding the other job-orders already planned at the time “Tacc”, in which the job-order in question was acquired.

Said output vector, on the other hand, always contains information regarding the single operational job associated with the sample considered, but available in the final balance once the job-order has been completed. In particular, it contains an indication of the true beginning and end of the operational job performed, and information regarding the actual working center that performed the operational job.

The production of such a training database is the essential prerequisite for training a mathematical identification model that allows to significantly improve the forecasts on the actual processing times of the job-orders, which are acquired, overcoming the mere statistical characterization that today appears as the only way to get information on the completion times of the various job-orders that are acquired by manufacturing companies that work on order.

The main advantage of the present invention consists in the fact that its teachings allow to apply a process that satisfies all the main objectives for which it was conceived.

### BRIEF DESCRIPTION OF THE DRAWINGS

This invention also has further advantages, which will become more evident from the following description, which illustrates further details of the invention itself through some forms of implementation, from the attached claims, which form an integral part of this description, and from the attached figures in which:

FIG. 1a shows a simplified block diagram of the planning process of manufacturing activities, as it is implemented according to current practice in companies that work on order.

FIG. 1b schematically represents how the computerized representation of a job-order is transformed by passing from the representation of the planned job-order to the representation of the same job-order as it has been actually processed.

FIG. 2 schematically represents a computerized representation of the planned operational jobs in the context of a manufacturing company that works on order.

FIG. 3 summarizes the structure of the computer representation of the samples of the training set for a mathematical model applicable for identifying the real working context of a manufacturing company, according to the teachings of the invention.

### DETAILED DESCRIPTION OF THE INVENTION

The invention is based on the intuition of using the final information relating to all the operational jobs carried out by a company, to identify as much as possible the mechanisms that are not evident, and not known, which make it difficult to predict the completion times of each individual operational job, in the execution of manufacturing production orders. It is foreseeable that the teachings of the invention will find increasing application, the more manufacturing companies working on orders will resort to the use of IT tools to oversee their processes of planning, management and control of their production activities.

The teachings of the present invention therefore aim to exploit data and methodologies that are already spreading irreversibly in the industry, without however requiring the use of specific tools; but providing the essential indications to exploit information that certainly must be available on the IT systems of many companies, whatever the management control programs that these companies will adopt.

The problem can be approached as a classic identification problem: i.e., the problem of formally representing, by means of a transfer function, a system whose laws are not known (and whose output is conditioned, at least in part by random variables), but of which, it is known only a large set of input and output samples of the system to be identified. Identification issues constitute a well-controlled class of mathematical problems at the research level. Especially in the last few decades, thanks to the enormous possibilities offered by numerical computation, the known identification techniques have begun to arouse strong interest also in the world of real applications, to the point that various identification methods have been developed, supported by very powerful software tools, available on the market also in versions aimed at the industrial world, and not limited to the world of research and laboratories.

However, although much work is also being done on the usability of these tools, the known identification techniques are not, by their nature, directly applicable to every single practical problem. So much so that a significant and creative effort is required to effectively apply the aforementioned known identification techniques to each specific practical problem.

For this reason, the individual applications of these techniques to specific identification problems are often considered, as such, real research results. They are published as such, and they are often also subject to patent protection.

In the case of interest of the present invention, the problem is particularly complex, and if faced without the necessary precautions it risks giving birth to solutions that are too specific, and not generalizable to sufficiently large classes of cases; while the present invention aims to offer indications applicable with a broad generality in the context of the processes performed by manufacturing companies that work on order.

The invention, therefore, does not focus its attention on the choice of the identification method.

As an operative working hypothesis, and only for the purpose of illustrating the real inventive nucleus presented in this patent application, it is hypothesized to use the model of a “neural network” of the “feed-forward” type to identify the unknown mechanisms that cause discrepancies between the foreseeable execution times, when planning an order, and the actual processing times.

Consequently, a presentation of the “neural networks” tool will not be proposed (for which reference should be made to the impressive literature on the subject: see e.g. S. Haykin, “Neural Networks: a comprehensive foundation”-Prentice Hall, 2001, or, the most recent text, by van Gerven M, Bohte Seds. “Artificial neural networks as models of neural information processing”-Frontiers Media, Lausanne, 2018), nor will be presented other known identification methods.

It is therefore assumed that these tools are known and available for use by the person skilled in the art, even without particular exercise of inventive step.

Among the various technical problems which instead must be faced in order to apply the aforementioned identification methods, there is one which is particularly decisive for the achievement of the objectives set by the present invention. This essential technical problem consists in the IT formalization of a set of data that can be used to train a “feed-forward neural network”, so that it is able to calculate with good reliability the deviations between the planning and the actual execution of the processes that are necessary to satisfy an order concerning a manufacturing production.

It is emphasized, at this point (and then it will no longer be repeated, but the concept must always be considered valid for the whole exposition of the invention), that once the data of the sample used for the identification problem have been formalized, the information that can be extracted from this sample data set, although not yet highlighted, are definitively fixed.

The sample therefore definitively limits the results that are achievable: a sample data set full of meaning leads to results, while a poorly constructed sample is destined not to produce anything interesting. At the same time, the sample data set cannot be too dispersive, or simply consist of all the data available, in their raw form, resulting from the computer systems that produce such data. And this applies to any identification method adopted: regardless of which “neural network” model is adopted (and there are many) and regardless of whether other methods are used, even if not based on “neural networks”.

In reality, an approach that operates on the mass of unstructured raw data is also an approach that is very investigated among the most current research topics: in this regard we speak of “big data”. This approach is also theoretically feasible, it is an alternative to the present invention, and requires enormous processing complexity; moreover, it requires an even greater quantity of data than that which can be foreseen in the cases of application of the present invention. At the moment, therefore, this approach does not appear particularly promising, and it makes sense to pursue it only in the absence of alternatives.

The present invention, therefore, has a general character, and offers an original solution to an essential technical problem for achieving the intended purposes.

The first step, necessary, to formalize a significant sample of data to be used to identify the hidden mechanisms that underlie a complex and partially (at least apparently) random process, consists in identifying a computer representation of the input and output data of the observed phenomenon, at least in relation to its parts that can be represented by computer.

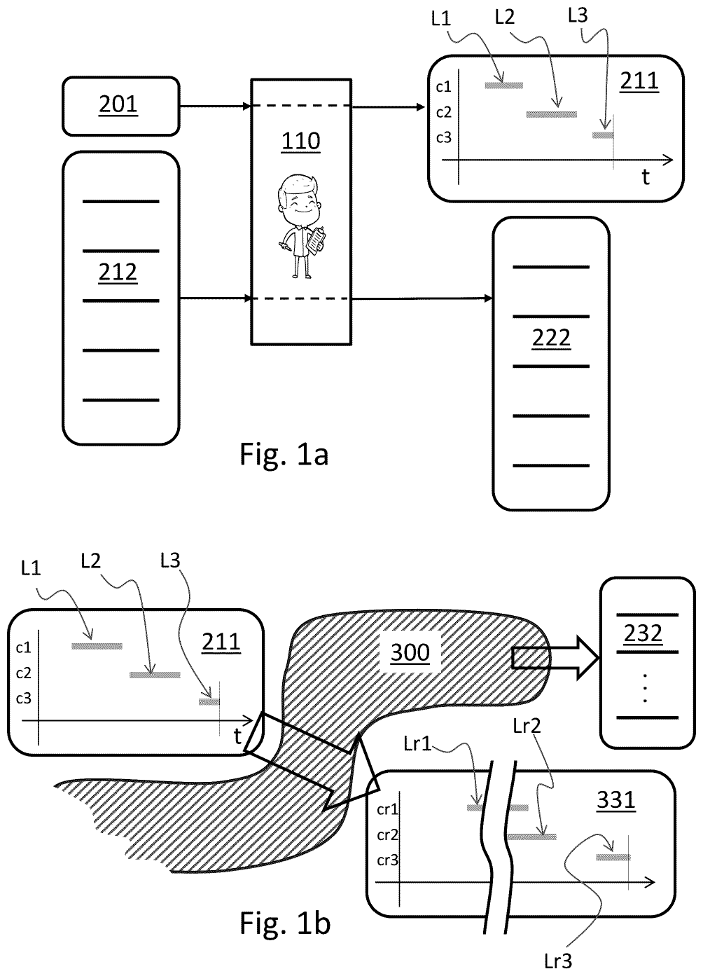

This first step is illustrated with the aid of FIGS. 1a and 1b, which highlight the essential structure of the formalization adopted in the context of the present invention.

FIG. 1a schematizes the current practice that is generally adopted in the manufacturing sector: that is, the current practice that has already been illustrated in the first part of this description, and which is recalled here below for convenience. The starting information are:
the first information (201) concerning the new orders that are continuously acquired, and
the company operational situation (212) in which new orders are grafted.

FIG. 1a shows a first IT representation of a job-order, indicated with the number 201, as this is acquired by a manufacturing company. The representation 201 of the just-acquired job-order contains only the acquisition information, and typically does not yet contain any information on how the order will be fulfilled.

The representation 201, at the computer level, contains at least a description of the product, the quantities that are required for this product, and a deadline for the delivery of the finished work.

At this point, the company must fulfill the job-order 201, and to do this it must take into account all the other jobs on which the company is committed. The number 212 indicates in FIG. 1a all the other orders on which the company is committed. The job-orders 212 are described more fully than the newly acquired order 201, as these orders 212 have already been planned, in the sense that they have already been divided into the sequence of operational jobs that are required, each operational job has been assigned to a work center (or to a particular type of work centers that can be considered interchangeable), and for each operational job a working time is indicated defined as duration, expressed in a deterministic way or through its statistical characterization, and through an indication about the interval of time in which this operational job can be carried out.

The temporal allocation of each planned operational job can be explicit, if the planning provides for this information, or implicit, if this operational job is just inserted in a queue of jobs to be performed by a certain work center. In the latter case, the start and end times, corresponding to the period of engagement of each work center, must be estimated taking into account the time needed to complete the previous operational jobs, time which, as already noted, may be expressed in probabilistic terms.

For the sake of simplicity of presentation, it is assumed that each work center performs a single operational job and that each operational job takes place without interruptions, therefore, from a temporal point of view, it is completely defined by the start and end moments. Obviously, this assumption introduces a simplification that is not always realistic, however, it is an assumption adopted for mere illustrative purposes, in order to facilitate the illustration of FIG. 1a. It is evident that the description of the orders 212 is possible in any case, even if the planning is more complex.

On the basis of the information of the job-order 201, at the moment of its acquisition, and of the information regarding the already planned jobs 212, the company plans the work to satisfy the job-order 201 as well. This planning activity is indicated in FIG. 1a with the number 110, and is an activity that every company must carry out, which can be performed in many ways, more or less computerized, and more or less accurately. It is a fact that every company can act as it sees fit. The result of the planning activity 110 is that the original job-order 201 becomes, from the IT point of view, a planned job-order, indicated with the number 211 in FIG. 1a, and for which it is possible to indicate a time of completion of the job: a moment which, as already said several times, is an often-inaccurate prediction of the true moment in which the order will actually be completed.

In the example of FIG. 1a, the job-order 211 provides for three operational jobs to be performed in substantial sequence, and indicated with the labels “L1”, “L2” and “L3”. Furthermore, it is envisaged that these three operational jobs are carried out by three distinct work centers, respectively indicated with the labels “C1”, “C2” and “C3”. As a result of the planning regarding job-order 211, it is possible that some work centers already committed have been involved, and therefore it is possible that other previously planned jobs have had to undergo some planning changes. For example, when an operational job of the new job-order is inserted in a job queue, not in the last place, but in an intermediate position (for example because it is an operational job belonging to an order for which it is expected to give priority), all subsequent operational jobs, obviously, undergoes a delay. Consequently, a further effect of the planning activity 110 is an overall update of the entire planning of all the manufacturing processes: the number 222 therefore indicates the set of all the other planned job-orders, and updated with respect to the planning version 212, as it was before the presence of the new job-order 211.

The IT history of job-order 211, however, does not end with its planning: on the contrary, the most substantial part has yet to unfold, and this history is briefly illustrated in FIG. 1b. In fact, the story of the planned job-order 211 continues to be a story that takes place significantly also on an IT level, because, as previously explained, a growing number of companies implement computerized and very punctual management control processes; and therefore, during the actual execution of the various “L1”, “L2” and “L3” operational jobs, many data are collected regarding the real progress of the operational jobs themselves.

The “L1”, “L2” and “L3” operational jobs are therefore enriched with information, and in particular their computer representation is enriched with real data that are added to the data provided in the planning stage.

For example, the real moments of beginning and finish of the processing are acquired: then the computer representation of the job-order 211 (which originally includes only planning data) is transformed into the computer representation indicated in FIG. 1b with the number 331, in which the planned operational jobs “L1”, “L2” and “L3”, become performed operational jobs, indicated in turn with the labels “Lr1”, “Lr2” and “Lr3”.

In addition to a physiological modification of the real moments of beginning and finish of the processing of the single operational jobs, other changes could also occur, for example by changing the work centers that have actually performed the “Lr1”, “Lr2” and “Lr3” operational jobs: therefore, the computerized representation of the executed job-order 331 also provides for the indication of the real work centers that performed the operations, indicated in the example of FIG. 1b with the labels “Cr1”, “Cr2” and “Cr3”.

In FIG. 1b, the real work context that transforms what is planned into something that actually happened is indicated with the number 300.

It is evident that the real work environment 300 is a complex world, unpredictable in many aspects, and which cannot be controlled in an absolutely precise way. This is precisely the real working context 300 that the present invention aims to characterize, improving the predictability of the discrepancies between the planning objectives and the actual results of the processes.

Finally, for completeness, FIG. 1b also indicates a further effect of the unforeseen events that occur in said context of real work 300, namely the fact that the orders not yet completed require a continuous updating of the planning, depending on how it evolves, this time in reality, the execution of the various planned processes.

Therefore, the number 232 indicates the updated set of planned job-orders, as it results due to the unexpected events that occur during processing.

As regards the analyzes that can be carried out with actual data measured in the final balance, we take this opportunity to underline once again a conceptual difference between the statistical analyzes, which treat the measured values as random variables definable with statistical moments or with percentiles, and analyzes attributable to identification theory.

These second analyzes start from the assumption that the measured events are the output of a transfer function to be identified, and only a part (possibly small) of their variability is attributable to random and unpredictable variations to be treated as a sort of “noise”. It is clear that the perfect knowledge of the transfer function that describes the real system 300 would be very useful, but it is also clear that such an objective is to be considered unrealistic. There is probably not even a stable transfer function over time, and therefore the present invention has the more realistic objective of identifying a function that only partially reproduces the real phenomena occurring in the environment 300, so that the statistical characterization of the events measured in the final balance, and which concern the real progress of the work on the various planned job-orders, is a characterization that highlights uncertainty with less random variability than that observed in the planned and executed job-orders, according to current practice.

What has been represented electronically, as explained with the aid of FIGS. 1a and 1b, is what commonly happens, and currently, in most of the manufacturing companies that work on order.

The important element that is used for the purposes of the present invention is the set of data constituted by the computerized representations of the completed job-orders 331. The importance of these data lies in the fact that they preserve a wealth of experience of the company, coded in a IT way, and therefore it can be processed electronically.

With regard to this wealth of experience, it is worth highlighting a first characteristic: each executed job-order 331, theoretically (and also in practice), is different from the other, and even similar job-orders, from the point of view of initial planning, may be very different, because you work in different real work contexts 300 (for example in moments of difficulty in the company, or in moments of low work).

It is therefore difficult to build a sufficiently large sample of data to train a “neural network” or any other identification model: a significant set of real data that is suitable for capturing regularities and hidden mechanisms that characterize the behavior of the real work context 300; especially if the set of processed job-orders is considered as a training set for the identification model.

An important insight of the present invention consists in considering the individual “operational jobs”, that make up the execution of the job-orders, as the input samples of the identification model.

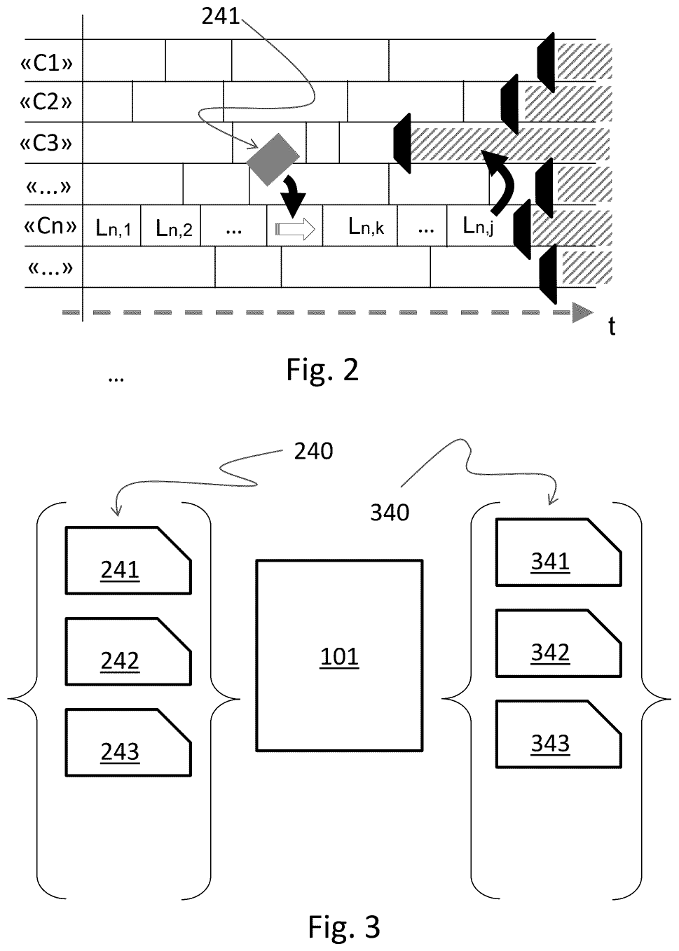

FIG. 2 shows, in tabular form, a possible computer representation of all the operational jobs planned by a manufacturing company at a given moment. The rows of the table in FIG. 2 are indicated with labels [“C1”, “C2”, “C3”, . . . , “Cn”, . . . ] which identify the various work centers available to the company.

In the generic “Cn” row you can find, allocated in sequence from left to right, in chronological order of execution, the jobs planned for the generic “Cn” work center (as well as in all the other rows there are the jobs assigned to the others work centers). These operational jobs, in the row corresponding to the “Cn” work center, are also indicated with labels that uniquely identify them [Ln, 1, Ln, 1, . . . , Ln, k, . . . , Ln, j].

FIG. 2 also shows a new operational job that is about to be assigned to the “Cn” work center and indicated with the number 241. Said new operational job 241, due to a planning decision, has been assigned to the “Cn” work center, and it is allocated, for its execution, before the operational job Ln, k, already previously assigned; the latter therefore, having to be performed after the new operational job 241, will be delayed.

Another possible effect of the insertion of the new operational job 241, assigned to the “Cn” work center could be the reassignment of the last operational job in load to the “Cn” work center, indicated with the label “Ln,j”: the latter could in fact be assigned to another work center, for example the “C3” work center. This shift could be decided due to the fact that the “C3” work center is free beforehand, and being a work center equipped to perform said operational job Ln,j, it might make sense to engage it on an operational job that had previously been assigned to another work center.

By focusing attention on the computer representation of the individual operational jobs, and not on the entire job-orders, there are at least two operational advantages. The first advantage is that the number of descriptive parameters is smaller, and each parameter can assume values in an easily definable domain, and this advantage affects the size of the identification model: for example, a “neural network” of reasonable size can be adopted, with a quite limited number of input nodes.

The second advantage consists in the fact that the number of samples of operational jobs is obviously greater than the number of the entire job-orders, and this fact facilitates the generation of a quite significant training sample.

Different operational jobs can be common or similar to different orders, and the training database thus constructed is naturally predisposed to better represent mechanisms that impact on individual operational jobs, i.e., the structural mechanisms which characterize the corporate work environment. These mechanisms could be hidden by the mechanisms associated with the order dynamics, if the training set were organized by order. Furthermore, the data base, thus broken down, allows to grasp well, and in a direct way, also the mutual correlations between the different orders and between the operational jobs assigned to different work centers.

However, the organization of the sample by operational jobs must not run the risk of losing other information for not having them well represented. It is therefore necessary to associate to the single training samples (which by choice are associated to single operational jobs) also other context information that describes in which context, in fact, each single real operational job has been processed. At the same time, the utmost care must also be paid to the conciseness of the context information, to keep reasonable the size and structure of the data entering the identification model.

FIG. 3 schematically represents the basic structure of each input/output sample of the training data set for the identification model.

The number 101 indicates the generic mathematical identification model chosen to face the problem posed by the present invention. Since the latter is not a specific object of the invention, it is not described in detail; however, in a preferred implementation form this identification model 101 is a “neural network”, among the various “neural network” architectures the non-recurring architectures called “feed-forward” appear to be a very suitable choice for the application considered in the present invention.

The number 240 indicates the input vector of each individual sample, while the number 340 indicates the output vector of each individual sample: and the set of all samples constitutes the training database of the identification model 101.

It is essential that each value contained in vectors 240 and 340 can be extrapolated by processing the data made available by the computer representations illustrated with the aid of the previous FIGS. 1a and 1b.

The number 241 indicates a sub-vector of the input vector 240 of each individual sample. Sub-vector 241 contains the essential data of each single planned operational job; and it is taken from the computer representation of each planned job 211. In particular, the sub-vector 241 will contain values attributable to the start and finish times foreseen at the time of planning and a value attributable to the first assigned work center (or attributable to a set of work centers enabled to take in charge of such processing).

As previously said, however, in order not to lose information, it is not sufficient to describe the planned operational job that make up the training sample without also representing, as completely and concisely as possible, information regarding the context in which each individual operational job is first planned, and then executed.

The number 242 therefore indicates another sub-vector of the input vector 240 of each individual sample. The sub-vector 242 contains the essential data that describe the planned job-order 211 as a whole; also the sub-vector 242 is taken from the same computer representation of the planned job-order 211, from which the data of the sub-vector 241 are taken.

Among the most relevant and essential information, which must appear in all forms of implementation of the present invention, the sub-vector 242, representative of the general context of the job-order 211, includes:
information regarding the length of the job-order as a whole, both in terms of time and in terms of the number of distinct operational jobs that compose it;
information on the position of the operational job corresponding to sub-vector 241 in the context of the overall job-order, i.e., if it is an operational job that must be carried out at the beginning (among the first jobs) or towards the end.

Furthermore, among the most relevant information, which are present in the preferred implementation forms, the sub-vector 242, representative of the context of the job-order 211, also includes:
information on the priority, or on the importance of the order 211 as a whole, being such quantitative information expressed with an appropriate metric;
one or more indicators expressing the complexity of the job-order, also these possibly expressed by resorting to the definition of an appropriate metric; such information, for example, could highlight whether the job-order in question allows for a lot of parallelization of the processes, or if there are significant constraints on the sequence with which the various operational jobs must be performed; such complexity indicators can certainly be defined in many ways and, typically, they are linked to the specific industrial environment in which the company operates.

Always in order not to lose information, even the information that represents the context of the order (as expressed in sub-vector 242) is not sufficient: in fact, it is important to keep track of the overall work context in which the company is involved, according to what is known at the moment of the planning of the operational job represented with sub-vector 241.

Therefore, the number 243 indicates a third sub-vector of the input vector 240 of each individual sample. Sub-vector 243 contains the essential data describing the other orders planned at the time of the acquisition of the job-order 201 corresponding to the planned job-order 211, from whose IT representation, also the sub-vectors 241 and 242 are taken. Sub-carrier 243 is therefore taken from the computer representation of the planned job-orders 212 at the time of the acquisition of the order 201.

Said sub-vector 243 is particularly important, because the starting data from which it must be taken can be very many. In fact, it is the amount of data contained in the table presented in FIG. 2, which must therefore be summarized effectively. It is appropriate that the size of the sub-vector 243 is possibly prefixed, as, in general, is the structure of the identification model 101.

Below there is mentioned some interesting information, because it can bring out those mechanisms that are being sought, and which can be quantitatively synthesized in sub-vector 243. This information is therefore included in the preferred implementation forms of sub-vector 243.
Dimension of the table in FIG. 2, highlighting the length of the rows, both in terms of time, indicating how long the work center corresponding to each row already has planned activities in charge, and both in terms of the number of operational jobs, which are already planned for each work center.
Position of insertion of the operational job 241 at the time of planning, indicating whether it has been inserted at the end (or towards the end) of a queue, or if it has occupied one of the first places by moving other processes, and the importance of these latter.
How many operational jobs, in the table, can no longer be delayed, or are not very delayable, because a further delay would involve the risk of not respecting delivery times.

For each sample of the training set, which corresponds to each individual planned operational job, at least three sub-vectors can therefore be calculated, whose numerical values are certainly deductible from the computer data in possession of the company.

In general, the complete input vector 240, which, in various forms of implementation, can also include other data in addition to those defined in the three sub-vectors 241, 242 and 243, is always, and in any case, deductible from computer data of which the company must be in possession.

In each training sample there must also be an output vector 340, associated with each input vector 240, and built as explained above.

Also said output vector 340 must have some essential structural characteristics.

The number 341 indicates a value (which can also be alternatively expressed as a sub-vector) which represents the information relating to the deviation, with respect to the start expected in the planning stage, of the real start of the operational job associated with the corresponding input vector 240.

The number 342 indicates a value (which can also be expressed as a sub-vector) which represents the information relating to the deviation, with respect to the finish expected in the planning stage, of the real end of the operational job associated with the corresponding input vector 240.

The number 343 indicates a value, which in a preferred implementation form is a Boolean value, which indicates the possibility that the real executed operational job associated with the corresponding input vector 240, has been performed by a work center other than the planned work center.

For each sample of the training set, which corresponds to each individual planned activity, an output vector 340 to be coupled to each input vector 240 can therefore be calculated, again starting from the computer data in possession by the company.

Even the output vector 340, in various forms of implementation, can also include other data in addition to those defined in the three sub-vectors 341, 342 and 343 and, it too, is always and in any case deductible from computer data of which the company must be in possession.

### Variants and Concluding Remarks

In summary, the teachings of the present invention allow to satisfy the purposes for which it was conceived by exploiting in an unprecedented way two intuitions having a technical content.
The first intuition consists in recognizing that in manufacturing companies that work on orders, historically, the experience of the workers is a strategic resource to work with the necessary flexibility (each order, in fact, is a project that must be engineered on its own). But the wealth of experience of a company is also preserved, and in a potentially more complete way, in the large amount of data produced by management monitoring and control systems, which are increasingly spreading in the manufacturing industrial landscape. Experience, therefore, goes from being a purely humanistic factor to becoming a technical factor in all respects: a heritage preserved in the memories of computer systems.
second intuition consists in the use of mathematical tools of identification theory, to extract the aforementioned wealth of experience from the data that are now available in every company.

The inventive step associated with the aforementioned two intuitions consists in the fact that, although the necessary data and information are, as mentioned, available in theory, a training set of data, as such, suitable for exploiting an identification model, is not actually available.

It is therefore necessary to provide for the construction of a set of training data, starting from the very elementary data (and, as such, far from being synthetic) produced by the aforementioned monitoring and management control systems.

The exercise of inventive step is required by the fact that the models that can be used for the identification of complex systems are not applicable in a standard way but they must be constructed in harmony with the type of problem that must be solved and, above all, they must be suitable for exploiting the structure of the data set used for training (i.e., the process which, starting from empirical data, defines the transfer function that simulates the real complex system that we intend to identify).

The structuring of the sample set for training must be carried out paying great attention not to waste the wealth of information stored in the starting raw data, that is, the experience that you want to extract. Often, in fact, it is precisely this phase of construction of the sample data set that jeopardizes the success of the application of the mathematical methods of identification.

On the other hand, the training sample must necessarily be constructed and structured appropriately, as it is not possible to use the available data in their raw form.

The training sample data set must be built specifically to apply the aforementioned identification methods with sufficient generality, so that they are effective for the concrete application indicated in the present invention: i.e., in scenarios where each company is different from the other, where they plan their work differently and monitor it with different systems.

The invention therefore indicates the essential characteristics of the identification model, in particular, it indicates some characteristics that are considered essential for the structure that the training data sample must have. Assuming the adoption of these features, which must be considered the only truly essential thing, the invention can be implemented according to numerous variants: above all, in relation to the type of identification model used. In fact, it is reiterated that the use of a “feed-forward neural network” is only indicated as a preferred form of implementation.

The size of the model can also be decided according to many variations, for example depending on the size of the company, and taking into account that the more complex and larger the identification model, the more difficult it is to make it converge towards a satisfactory learning state. Regarding the choice of the size and topology of “neural networks” (but the same is true for other identification models), please refer to the extensive literature on the subject which indicates many strategies, especially of the heuristic type.

The operator interface may be implemented in many ways too. In the preferred implementation forms, the system taught in the invention is closely integrated with the software and systems of the company, which are dedicated to manufacturing monitoring, and management control, and it may share with these the interfaces to the operator and to the other corporate systems.

The system taught in the present invention, therefore, can be implemented in many forms and variants, especially due to its intrinsic propensity to integrate with other IT systems of the company.

The strength of the present invention is destined to maintain its distinctive relevance for a significant time, as it is based on an unprecedented intuition that allows the data produced for other reasons to be exploited in a new way. And this innovative exploitation of information produces results not known to the state of the art, which can significantly change the manufacturing processes in the companies that work on order.

Then, especially in the context of the expected evolutionary scenarios, the invention lends itself to incorporating and supporting further development and refinement efforts, capable of increasing the performance of the invention as described in the light of current scenarios. Therefore, further developments could be made by the man skilled in the art without thereby departing from the scope of the invention as it results from this description and the attached claims, which form an integral part of this description; or, if said developments are not included in the present description, they may be the subject matter of further patent applications associated with the present invention, or dependent on it

1. A system for forecasting processing times adopted in a manufacturing firm which works on order, which is a real system (300), which transforms acquired job-orders in executed job-orders;
and said system for forecasting processing times comprises a mathematical model of identification (101) implemented in a digital subsystem, which comprises computing means and memory units;
and said mathematical model of identification (101) comprises a training data set; and in occasion of any acquisition of a new job-order (201), which occurs at a generic time “Tacc”, it stores the following information:
a. an informatic representation (212) of all the job-orders that, at said generic time “Tacc”, are already acquired by said manufacturing firm, and are scheduled but not executed, wherein said acquired job-orders are represented subdivided into operational jobs, and said operational jobs are represented by information regarding their time scheduling and information also regarding the work centers of said manufacturing firm to which said operational jobs are assigned to be executed;
b. a new informatic representation (211) of said new job-order (201), acquired at said generic time “Tacc”, wherein said new informatic representation (211) of said new job-order (201) as it results after the scheduling of said new job-order (201), and said new informatic representation (211) is again represented subdivided into operational jobs, and said operational jobs are represented by information regarding their time scheduling and information also regarding the work centers of said manufacturing firm to which said operational jobs are assigned to be executed;
c. an informatic representation (222) of all the job-orders acquired by said manufacturing firm, at the time when also said new job-order (201) has been scheduled to be executed, wherein said acquired job-orders are represented subdivided into operational jobs, and said operational jobs are represented by information regarding their time scheduling and information also regarding the work centers to which said operational jobs are assigned to be executed;
d. an informatic representation of all the job-orders executed (232) by said manufacturing firm, in which the informatic representation of each single executed job-order (331) is represented subdivided into its operational jobs, and said operational jobs are also represented by information that states the actual moments in which said operational jobs really have started and ended, and information also regarding the work centers that have actually executed out said operational jobs;
and said digital subsystem is characterized in that:
it is also configured to calculate and produce said training data set suitable to train said mathematical model of identification (101) in order to make it the informatic image of said manufacturing firm that work on order, which is a real system (300), which transforms the information regarding any scheduled operational job (as explained in the preceding points “a”, “b” and “c”) into the information regarding this operational job when it has been actually executed (as explained in the preceding point “d”);
said training data set contains a plurality of samples, in which each of said samples is associated with a single operational job belonging to an executed job-order, and each sample is in turn constituted by an input vector (240) and by an output vector (340);
and said input vector (240) is structured to contain at least the following information regarding the single operational job associated with the considered sample:
in a first sub-vector (241) there are values regarding the initial and final times expected at the time of the first scheduling following the acquisition of the corresponding job-order, and a value indicating the first work center assigned,
in a second sub-vector (242) there are values attributable to the information regarding the length of the job-order as a whole, both in terms of time duration and in terms of the number of distinct operational jobs which compose it, and values indicating the position of said operational job with respect to the other operational jobs of the same job-order,
in a third sub-vector (243) there are values calculated from the informatic representation of the other planned job-orders (212) at the time of the acquisition of the considered job order (201);
and said output vector (340) is structured to contain at least the following information regarding the single operational job associated with the considered sample:
a first value (341), which can also be alternatively expressed as a sub-vector, contains the information relating to the deviation of the real initial time, with respect to the initial time foreseen in the planning stage, of the operational job associated with the corresponding input vector (240),
a second value (342), which can also be alternatively expressed as a sub-vector, contains the information relating to the deviation of the real final time, with respect to the final time foreseen in planning, of the operational job associated with the corresponding input vector (240),
a third value (343) indicates the possibility that the actual operational job associated with the corresponding input vector (240), was performed by a work center other than the planned work center.

2. The system for forecasting processing times in the manufacturing sector, according to claim 1, wherein said mathematical identification model (101) consists in a “neural network”, and said digital subsystem is configured with a calculation program suitable for training said mathematical identification model (101) with said training data set produced as indicated in claim 1.

3. The system for forecasting processing times in the manufacturing sector, according to claim 1, wherein said second sub-vector (242) of the input vector (240) there are also contained values which express, in a suitable metric, information about the priority of the planned job-order (211), of which the considered operational job is part.

4. The system for forecasting processing times in the manufacturing sector, according to claim 1, wherein said second sub-vector (242) of the input vector (240) there are also contained values which express in a suitable metric, one or more indicators of the complexity of the considered job order (211).

5. The system for forecasting processing times in the manufacturing sector, according to claim 1, wherein said third sub-vector (243) of the input vector (240) it is structured to also contain information expressing the number of the other planned operational jobs assigned, for being performed, to the same work center to which the operational job associated with the considered sample is also assigned.

6. The system for forecasting processing times in the manufacturing sector, according to claim 1, wherein said third sub-vector (243) of the input vector (240) it is structured to also contain information expressing the overall number of all the operational jobs already planned and to be execute, assigned to each work center, at the time “Tacc”, that is the time of the acquisition of the job-order (201) which includes the operational job associated with the considered sample.

7. The system for forecasting processing times in the manufacturing sector, according to claim 6, wherein said third sub-vector (243) of the input vector (240) it is structured to also contain information expressing the total number of operational jobs, planned for being executed, assigned to each work center, at the time “Tacc”, and whose execution cannot be delayed without determining that the corresponding job-order, of which said operational jobs are part, is completed late with respect to a predetermined final completion deadline.
